(19) United States
(12) Patent Application Publication
(10) Pub. No.: US 2017/0131601 A1
(43) Pub. Date: May 11, 2017

(54) DISPLAY PANEL, ITS MANUFACTURING METHOD, AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Songyang JIANG, Beijing (CN); Lei GUO, Beijing (CN); Ke DAI, Beijing (CN); Yongjun YOON, Beijing (CN)

(73) Assignees: BOE TECHNOLOGY GROUP CO., LTD., Beijing (CN); HEFEI XINSHENG OPTOELECTRONICS TECHNOLOGY CO., LTD ., Hefei (CN)

(21) Appl. No.: 15/241,687

(22) Filed: Aug. 19, 2016

(30) Foreign Application Priority Data
Nov. 6, 2015 (CN) 201510751251.8

(51) Int. Cl. G02F 1/1343; G02F 1/1335; G02F 1/1368; G02F 1/1362

(52) U.S. Cl. CPC G02F 1/134336; G02F 1/136286; G02F 1/133514; G02F 1/133512; G02F 1/13439; G02F 1/1368; G02F 2001/133302

(57) ABSTRACT

The present disclosure provides a display panel, its manufacturing method and a display device. The method includes a step of forming pixels at a display region and dummy pixels at a non-display region surrounding the display region. The step of forming the dummy pixels includes forming a plurality of dummy pixels at a position of the non-display region adjacent to the display region. Each dummy pixel has a structure identical to the pixel at the display region, and in the case that an image is displayed by the display panel, each dummy pixel is in a dark state.

### CROSS-REFERENCE TO RELATED APPLICATIONS

This application claims priority to Chinese application No. 201510751251.8, filed Nov. 6, 2015, which is hereby incorporated by reference in its entirety.

### TECHNICAL FIELD

The present disclosure relates to the field of display technology, in particular to a display panel, its manufacturing method and a display device.

### BACKGROUND

During the manufacture of a liquid crystal display (LCD), at first, a plurality of wires for pixel circuits is formed on a thin film transistor (TFT) substrate, and such structures as color filter layer and black matrix are formed on a color filter (CF) substrate. Depending on different constitutions, the structure at the active area (AA) on the TFT substrate is greatly different from the structure at the peripheral regions around the AA, and the structure at the AA on the CF substrate is also greatly different from the structure at the peripheral regions around the AA. Therefore, during the cell formation, liquid crystals may be diffused at an edge of the active area in a different way from that in the active area. In addition, there is a thickness difference at the edge of the active area of each of the TFT substrate and the CF substrate (i.e., the active area has a thickness greater than a thickness of a layer at a region beyond the active area), and after the cell formation in a vacuum, this thickness difference may lead to an uneven cell thickness at a periphery of the LCD. In the case that light beams from a backlight source are transmitted through a liquid crystal cell, they may have different optical distances, and various optical distance differences may occur, thereby the light beams exiting the liquid crystal cell may be in different colors. Such a “yellowish” phenomenon occurring at the periphery of the LCD is just caused by the large fluctuation in the optical distance differences, especially apparent for a large-size product.

The image quality of a display panel may be adversely affected by the “yellowish” phenomenon, and the analysis of this phenomenon may prolong a development circle of the product and increase the development cost. However, there is no effective solution for this defect in the art.

### SUMMARY

A main object of the present disclosure is to prevent the occurrence of the yellowish phenomenon at the periphery of the large-size display panel, so as to improve the image quality and reduce the development cost.

In one aspect, the present disclosure provides in some embodiments a display panel, including a display region and a non-display region surrounding the display region. A plurality of dummy pixels is arranged at a position of the non-display region adjacent to the display region, each dummy pixel has a pixel structure identical to a pixel at the display region, and in the case that an image is displayed by the display panel, each dummy pixel is in a dark state.

Optionally, each dummy pixel is disconnected from a corresponding gate line or data line.

Optionally, the display panel further includes an array substrate, and a color filter substrate provided with a black color filter layer at a position corresponding to each dummy pixel.

Optionally, the display panel further includes an array substrate, and a color filter substrate provided with a black color filter layer at a position corresponding to each dummy pixel, and each dummy pixel is disconnected from a corresponding gate line or data line.

Optionally, the number of columns of the dummy pixels beyond a column of the pixels at an edge of the display region is greater than or equal to 9, or the number of rows of the dummy pixels beyond a row of the pixels at an edge of the display region is greater than or equal to 9.

Optionally, the number of columns of the dummy pixels beyond a column of the pixels at an edge of the display region is greater than or equal to 9, and the number of rows of the dummy pixels beyond a row of the pixels at an edge of the display region is greater than or equal to 9.

In another aspect, the present disclosure provides in some embodiments a display device including the above-mentioned display panel.

In yet another aspect, the present disclosure provides in some embodiments a method for manufacturing a display panel, including a step of forming pixels at a display region and dummy pixels at a non-display region surrounding the display region. The step of forming the dummy pixels includes forming a plurality of dummy pixels at a position of the non-display region adjacent to the display region. Each dummy pixel has a structure identical to the pixel at the display region, and in the case that an image is displayed by the display panel, each dummy pixel is in a dark state.

Optionally, the step of forming the dummy pixels includes disconnecting each dummy pixel from a corresponding gate line or data line.

Optionally, in the case that the display panel includes an array substrate and a color filter substrate, the step of forming the dummy pixels includes forming a black color filter layer at a position of the color filter substrate corresponding to each dummy pixel.

Optionally, in the case that the display panel includes an array substrate and a color filter substrate, the step of forming the dummy pixels includes forming a black color filter layer at a position of the color filter substrate corresponding to each dummy pixel, and disconnecting each dummy pixel from a corresponding gate line or data line.

Optionally, the step of forming the dummy pixels includes forming greater than or equal to 9 columns of the dummy pixels beyond a column of the pixels at an edge of the display region, and/or forming greater than or equal to 9 rows of the dummy pixels beyond a row of the pixels at an edge of the display region.

According to the display panel, its manufacturing method and the display device in the embodiments of the present disclosure, the plurality of dummy pixels is provided at the non-display region beyond the display region of the display panel, and in the case that the image is displayed by the display panel, the dummy pixels are in the dark state. As a result, it is able to improve the cell thickness uniformity at the periphery of the display region, thereby to improve the cell thickness uniformity at the periphery of the display panel and prevent the occurrence of the yellowish phenomenon.

### DESCRIPTION OF THE DRAWINGS

FIGS. 1A-1C are curve diagrams of cell thicknesses of four sides of three liquid crystal display panels;

FIG. 2 is a schematic view showing the arrangement of dummy pixels according to one embodiment of the present disclosure;

FIG. 3 is another schematic view showing the arrangement of the dummy pixels according to one embodiment of the present disclosure;

FIG. 4 is yet another schematic view showing the arrangement of the dummy pixels according to one embodiment of the present disclosure; and

FIG. 5 is a flow chart of a method for manufacturing a display panel according to one embodiment of the present disclosure.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

For a conventional LCD panel, a layer at an active area of a glass substrate has a thickness greater than a layer beyond the active area, and in the case that liquid crystals are spontaneously diffused on the glass substrate, they may not be diffused in a manner as desired at a position where the uneven thickness occurs. After two glass substrates are arranged opposite to each other to form a cell, cell thicknesses at positions adjacent to the active area may fluctuate greatly. In the case that light beams from a backlight source are transmitted through the liquid crystal cell, they may have different optical distances, and various optical distance differences may occur, thereby the light beams exiting the liquid crystal cell may be in different colors. Such a “yellowish” phenomenon frequently occurring at a periphery of the active area of a large-size LCD panel is just caused by the large fluctuation in the optical distance differences.

In order to facilitate the understanding of the yellowish phenomenon frequently occurring at the periphery of the active area, a thickness difference at a display region will be analyzed hereinafter.

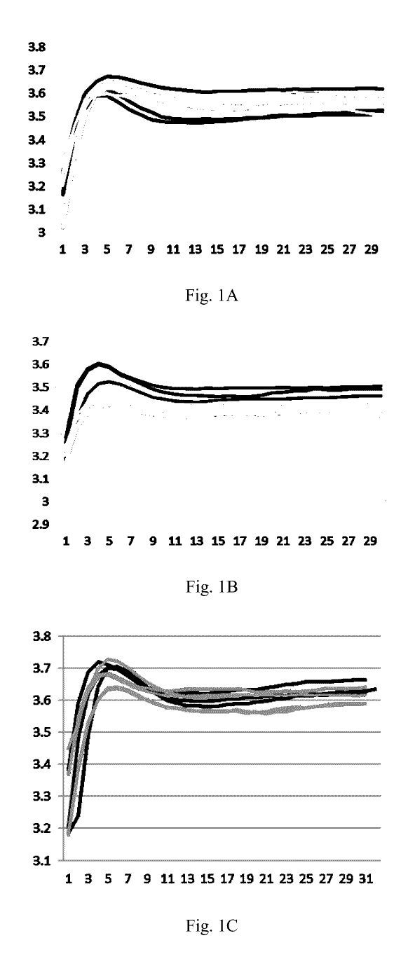

FIGS. 1A-1C show cell thicknesses at four sides of three large-size liquid crystal display panels where the yellowish phenomenon occurs. In FIGS. 1A-1C, the cell thickness at each side is measured in an outside-in manner, starting with a first pixel at an edge of the active area, so as to acquire two curves. As shown in FIGS. 1A-1C, the cell thickness at the periphery of the active area is obviously different from that in the active area. Essentially, the cell thickness becomes stable at a position corresponding to a ninth pixel from the edge of the active area, and the cell thickness fluctuates wildly at positions corresponding to the preceding eight pixels. In addition, a maximum cell thickness may occur before the cell thickness becomes stable. The uneven cell thickness at the periphery of the active area may lead to variations in the optical distances, so the light beams exiting the cell may be in yellow. In other words, the yellowish phenomenon at the periphery of the liquid crystal display panel is just caused by the difference between the maximum cell thickness and the cell thickness at a stable stage.

Usually, it is able to prevent the occurrence of the uneven cell thickness by adding a dummy pattern in the display panel, adjusting sizes of silicon balls inside the display panel, adjusting a height of a spacer at the periphery of the display panel, or changing a dripping mode of the liquid crystals onto a pattern, so as to prevent the occurrence of the yellowish phenomenon to some extent. However, in these ways, it is still unable to completely prevent the occurrence of the yellowish phenomenon. In some embodiments of the present disclosure, a plurality of dummy pixels is provided, so as to prevent occurrence of the uneven cell thickness at the active area, thereby to prevent the occurrence of the yellowish phenomenon.

The present disclosure provides in some embodiments a display panel, which includes a display region and a non-display region surrounding the display region. A plurality of dummy pixels is arranged at a position of the non-display region adjacent to the display region, each dummy pixel has a pixel structure identical to a pixel at the display region, and in the case that an image is displayed by the display panel, each dummy pixel is in a dark state. In other words, the dummy pixel differs from the pixel at the display region merely in that it cannot emit light normally.

Due to the existence of the display region, the display panel may include merely an array substrate, or both an array substrate and a color filter substrate.

In order to enable the dummy pixel to be in the dark state in the case that the image is displayed by the display panel, a display function of the dummy pixel may be prohibited in various ways. In the actual application, these ways may be selected in accordance with the structure of the display panel, and some of these ways will be described hereinafter.

In a first way, the display function of the dummy pixel may be prohibited by disconnecting it from a corresponding gate line or data line. This way may be adapted to the display panel which merely includes the array substrate, or the display panel which includes both the array substrate and the color filter substrate. In other words, even in the case that the display panel includes the color filter substrate, it is merely required to disconnect the dummy pixel at a peripheral region (i.e., the non-display region) of the array substrate from the corresponding gate line or data line, without any improvement in the color filter substrate.

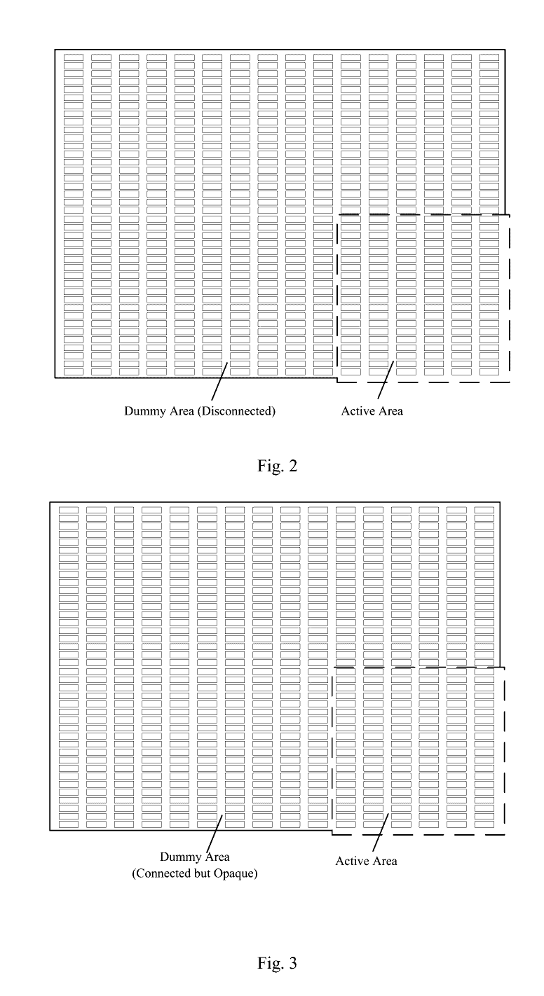

Referring to FIG. 2, which is a schematic view showing the arrangement of the dummy pixels, all pixels at the non-display region (i.e., pixels at the peripheral region) are disconnected from the corresponding gate lines or data lines, so as to form the dummy pixels that do not have the display function. In FIG. 2, the dummy pixels at the entire non-display region (i.e., the dummy area) cannot operate normally.

In a second way, in the case that the display panel includes the array substrate and the color filter substrate, the display function of the dummy pixel may be prohibited by providing the color filter substrate with a black color filter layer at a position corresponding to the dummy pixel, but without any improvement in the pixels on the array substrate. In other words, at this time, all the pixels at the non-display region of the array substrate are connected to the corresponding gate lines or data lines, and these pixels may operate normally and emit light. However, the light from the pixels may be shielded by the black color filter layer, so the normal display will not be adversely affected.

Referring to FIG. 3, which is another schematic view showing the arrangement of the dummy pixels, all the pixels at the non-display region of the array substrate are connected to the corresponding gate lines or data lines, and merely the black color filter layer is arranged on the color filter substrate at positions corresponding to these pixels to shield the light therefrom. In FIG. 3, the pixels at the entire non-display region (i.e., the dummy area) may emit light, but the light cannot pass through the black color filter layer.

In a third way, in the case that the display panel includes the array substrate and the color filter substrate, improvements may be made in both of them. For example, the color filter substrate may be provided with the black color filter layer at a position corresponding to the pixels at the non-display region (i.e., the dummy pixels), and meanwhile each dummy pixel may be disconnected from the corresponding gate line or data line.

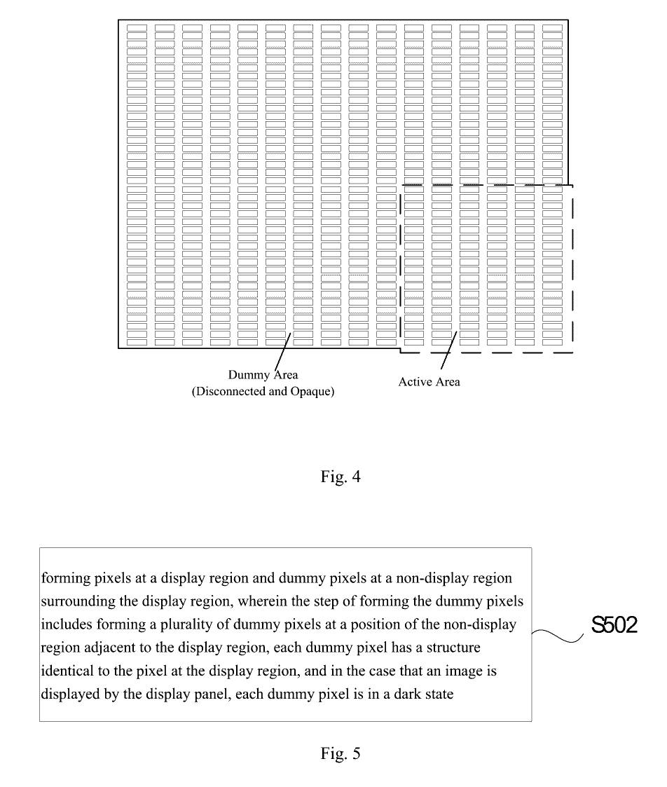

Referring to FIG. 4, which is yet another schematic view showing the arrangement of the dummy pixels, all the pixels at the non-display region are disconnected from the corresponding gate lines or data lines so as to form the pixels that do not have the display function (i.e., the dummy pixels), and meanwhile the color filter substrate is provided with the black color filter layer at the position corresponding to the dummy pixels. In FIG. 4, the pixels at the entire non-display region (i.e., the dummy area) cannot emit light, and the black color filter layer is opaque.

It should be appreciated that, FIGS. 2-4 merely show a portion of the display region and a portion of the non-display region.

In order to further prevent the occurrence of the yellowish phenomenon, apart from changing the pixels at the non-display region that should have displayed normally into the dummy pixels that cannot display normally, the number of rows and/or columns of the dummy pixels may be further defined. To be specific, the number of columns of the dummy pixels beyond a column of the pixels at an edge of the display region is greater than or equal to 9, or the number of rows of the dummy pixels beyond a row of the pixels at an edge of the display region is greater than or equal to 9. Optionally, the number of columns of the dummy pixels beyond a column of the pixels at an edge of the display region is greater than or equal to 9, and the number of rows of the dummy pixels beyond a row of the pixels at an edge of the display region is greater than or equal to 9.

It should be appreciated that, the number of rows and/or columns of the dummy pixels is determined in accordance with the curves in FIGS. 1A-1C. In this way, the maximum cell thickness may occur at the non-display region. At this time, because the dummy pixels at the non-display region cannot display normally, it is able to prevent the occurrence of the yellowish phenomenon due to the optical distance difference.

For the first way, no less than nine rows and/or nine columns (e.g., eleven rows*ten columns, or nine rows*nine columns) of dummy pixels may be added at the non-display region. Each dummy pixel has a structure identical to the pixel at the display region, with the only difference in that it cannot emit light. For example, each dummy pixel may be disconnected from the corresponding data line, so as to prevent the corresponding liquid crystals in the cell from rotating, thereby to prevent the dummy pixel from displaying the image normally. In this way, it is able to ensure the periphery of the display region to be at a stable cell thickness region, thereby to prevent the occurrence of a too large cell thickness difference.

For the second way, no less than nine rows and/or nine columns (e.g., eleven rows*ten columns, or nine rows*nine columns) of dummy pixels may be added at the non-display region of the array substrate, and each dummy pixel has a TFT structure identical to the pixel at the display region. In addition, the color filter layer at the non-display region of the color filter substrate is made of a black matrix material. At this time, the light from the dummy pixels may be shielded by the opaque color filter layer. As a result, it is able to prevent the image display at the display region from being adversely affected, and prevent the occurrence of the yellowish phenomenon.

For the third way 3, no less than nine rows and/or nine columns (e.g., eleven rows*ten columns, or nine rows*nine columns) of dummy pixels may be added at the non-display region of the array substrate, and each dummy pixel has a TFT structure identical to the pixel at the display region. In addition, the color filter layer at the non-display region of the color filter substrate is made of a black matrix material. These dummy pixels are disconnected from the corresponding data lines. At this time, the dummy pixels at the non-display region cannot emit light, and the color filter layer at the position corresponding to the dummy pixels is opaque, so the liquid crystals at the position corresponding to the non-display region cannot rotate. As a result, it is able to prevent the occurrence of the yellowish phenomenon as well as the light leakage.

The present disclosure further provides in some embodiments a display device including the above-mentioned display panel. The display device may be any product or member having a display function, such as a mobile phone, a flat-panel computer, a television, a display, a laptop computer, a digital photo frame or a navigator. The implementation of the display device may refer to the implementation of the display panel, and thus will not be particularly defined herein.

The present disclosure further provides in some embodiments a method for manufacturing a display panel which, as shown in FIG. 5, includes Step S502 of forming pixels at a display region and dummy pixels at a non-display region surrounding the display region. The step of forming the dummy pixels includes forming a plurality of dummy pixels at a position of the non-display region adjacent to the display region. Each dummy pixel has a structure identical to the pixel at the display region, and in the case that an image is displayed by the display panel, each dummy pixel is in a dark state.

In some embodiments of the present disclosure, the step of forming the dummy pixels may including: disconnecting each dummy pixel from a corresponding gate line or data line; in the case that the display panel includes an array substrate and a color filter substrate, forming a black color filter layer at a position of the color filter substrate corresponding to each dummy pixel; or in the case that the display panel includes an array substrate and a color filter substrate, forming a black color filter layer at a position of the color filter substrate corresponding to each dummy pixel, and disconnecting each dummy pixel from a corresponding gate line or data line.

The above ways for forming the dummy pixels have been described hereinbefore, and thus will not be particularly defined herein.

In order to improve the cell thickness uniformity and enable the maximum cell thickness to occur at the non-display region, the number of columns of the dummy pixels beyond a column of the pixels at an edge of the display region may be greater than or equal to 9, or the number of rows of the dummy pixels beyond a row of the pixels at an edge of the display region may be greater than or equal to 9. Optionally, in order to achieve a better effect, the number of columns of the dummy pixels beyond a column of the pixels at an edge of the display region may be greater than or equal to 9, and the number of rows of the dummy pixels beyond a row of the pixels at an edge of the display region may be greater than or equal to 9.

According to the method in the embodiments of the present disclosure, no less than nine rows and/or nine columns of dummy pixels may be added at the non-display region of the array substrate, so as to improve the cell thickness uniformity at the periphery of the display region, thereby to prevent the occurrence of the yellowish phenomenon.

As can be seen from the above, the dummy pixel has a structure identical to the pixel at the display region, and the color filter substrate is provided with the color filter layer at a position corresponding to the dummy pixels. Each dummy pixel on the array substrate has a complete pixel structure, with the only difference from the pixel at the display region in that it cannot operate normally (i.e., the liquid crystals at a position corresponding to the dummy area cannot rotate). In addition, the number of rows and/or columns of the dummy pixels may be greater than or equal to 9. As a result, it is able to improve the cell thickness uniformity at the display region, thereby to provide an identical optical distance for the light at the entire display region and prevent the occurrence of the yellowish phenomenon.

The above are merely the preferred embodiments of the present disclosure. Obviously, a person skilled in the art may make further modifications and improvements without departing from the spirit of the present disclosure, and these modifications and improvements shall also fall within the scope of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A display panel, comprising a display region and a non-display region surrounding the display region, wherein a plurality of dummy pixels is arranged at a position of the non-display region adjacent to the display region, each dummy pixel has a pixel structure identical to a pixel at the display region, and in the case that an image is displayed by the display panel, each dummy pixel is in a dark state.

2. The display panel according to claim 1, wherein each dummy pixel is disconnected from a corresponding gate line or data line.

3. The display panel according to claim 1, further comprising an array substrate, and a color filter substrate provided with a black color filter layer at a position corresponding to each dummy pixel.

4. The display panel according to claim 1, further comprising an array substrate, and a color filter substrate provided with a black color filter layer at a position corresponding to each dummy pixel, wherein each dummy pixel is disconnected from a corresponding gate line or data line.

5. The display panel according to claim 1, wherein the number of columns of the dummy pixels beyond a column of the pixels at an edge of the display region is greater than or equal to 9, or the number of rows of the dummy pixels beyond a row of the pixels at an edge of the display region is greater than or equal to 9.

6. The display panel according to claim 1, wherein the number of columns of the dummy pixels beyond a column of the pixels at an edge of the display region is greater than or equal to 9, and the number of rows of the dummy pixels beyond a row of the pixels at an edge of the display region is greater than or equal to 9.

7. A display device, comprising the display panel according to claim 1.

8. The display device according to claim 7, wherein each dummy pixel is disconnected from a corresponding gate line or data line.

9. The display device according to claim 7, wherein the display panel further comprises an array substrate, and a color filter substrate provided with a black color filter layer at a position corresponding to each dummy pixel.

10. The display device according to claim 7, wherein the display panel further comprises an array substrate, and a color filter substrate provided with a black color filter layer at a position corresponding to each dummy pixel, and each dummy pixel is disconnected from a corresponding gate line or data line.

11. The display device according to claim 7, wherein the number of columns of the dummy pixels beyond a column of the pixels at an edge of the display region is greater than or equal to 9, or the number of rows of the dummy pixels beyond a row of the pixels at an edge of the display region is greater than or equal to 9.

12. The display device according to claim 7, wherein the number of columns of the dummy pixels beyond a column of the pixels at an edge of the display region is greater than or equal to 9, and the number of rows of the dummy pixels beyond a row of the pixels at an edge of the display region is greater than or equal to 9.

13. A method for manufacturing a display panel, comprising a step of forming pixels at a display region and dummy pixels at a non-display region surrounding the display region, wherein
the step of forming the dummy pixels comprises forming a plurality of dummy pixels at a position of the non-display region adjacent to the display region, wherein each dummy pixel has a structure identical to the pixel at the display region, and in the case that an image is displayed by the display panel, each dummy pixel is in a dark state.

14. The method according to claim 13, wherein the step of forming the dummy pixels comprises disconnecting each dummy pixel from a corresponding gate line or data line.

15. The method according to claim 13, wherein in the case that the display panel includes an array substrate and a color filter substrate, the step of forming the dummy pixels comprises forming a black color filter layer at a position of the color filter substrate corresponding to each dummy pixel.

16. The method according to claim 13, wherein in the case that the display panel includes an array substrate and a color filter substrate, the step of forming the dummy pixels comprises forming a black color filter layer at a position of the color filter substrate corresponding to each dummy pixel, and disconnecting each dummy pixel from a corresponding gate line or data line.

17. The method according to claim 13, wherein the step of forming the dummy pixels comprises:
forming greater than or equal to 9 columns of the dummy pixels beyond a column of the pixels at an edge of the display region, and
forming greater than or equal to 9 rows of the dummy pixels beyond a row of the pixels at an edge of the display region.

18. The method according to claim 13, wherein the step of forming the dummy pixels comprises:
forming greater than or equal to 9 columns of the dummy pixels beyond a column of the pixels at an edge of the display region, or
forming greater than or equal to 9 rows of the dummy pixels beyond a row of the pixels at an edge of the display region.

19. The method according to claim 14, wherein the step of forming the dummy pixels comprises:
forming greater than or equal to 9 columns of the dummy pixels beyond a column of the pixels at an edge of the display region, and
forming greater than or equal to 9 rows of the dummy pixels beyond a row of the pixels at an edge of the display region.

20. The method according to claim 15, wherein the step of forming the dummy pixels comprises:
forming greater than or equal to 9 columns of the dummy pixels beyond a column of the pixels at an edge of the display region, and
forming greater than or equal to 9 rows of the dummy pixels beyond a row of the pixels at an edge of the display region.
